(19) United States
(12) Patent Application Publication
(10) Pub. No.: US 2006/0294126 A1
(43) Pub. Date: Dec. 28, 2006

(54) Method and system for homogeneous hashing

(76) Inventor: Afshin Ganjoo, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/165,791

(22) Filed: Jun. 23, 2005

(51) Int. Cl. G06F 7/00

(52) U.S. Cl. 707/101

(57) ABSTRACT

A method and system for homogeneous hashing is described. The method includes hashing data into a hash table using a first hash function and determining one or more subsequent hash functions to be used for one or more cells of the hash table. The subsequent hash functions may be determined based on the number of data entries that map to each cell of the hash table. The subsequent hash functions may be chosen to minimize collisions of data in the hash table. Remap information for the cells of the hash table may be stored in a reorganizer table. The data may then be rehashed into the hash table using the one or more subsequent hash functions and the stored remap information.

### TECHNICAL FIELD

Embodiments of the invention relate to hash tables, and more specifically to homogeneous hashing.

### BACKGROUND

In a typical hash table, a key tells you where in the table to look up data. However, two different data entries may have the same key, causing a collision in a cell of the hash table. One solution for this problem is to have the cell with the collision point to a new cell, which creates a linked list of all data that collides at that cell. Another solution is to increase the size of the hash table to minimize the number of collisions. However, the hash table may still have some empty cells and some cells with many collisions.

### BRIEF DESCRIPTION OF THE DRAWINGS

The invention is illustrated by way of example, and not by way of limitation, in the figures of the accompanying drawings in which like reference numerals refer to similar elements.

FIG. 1 is a block diagram illustrating a suitable computing environment in which certain aspects of the illustrated invention may be practiced.

FIG. 2 illustrates a typical hash table.

FIG. 3 illustrates a hash table according to an embodiment of the invention.

FIG. 4 illustrates a typical hash table.

FIG. 5 illustrates a hash table according to an embodiment of the invention.

FIG. 6 is a flow diagram illustrating a method according to an embodiment of the invention.

### DETAILED DESCRIPTION

Embodiments of a system and method for homogeneous hashing are described. In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

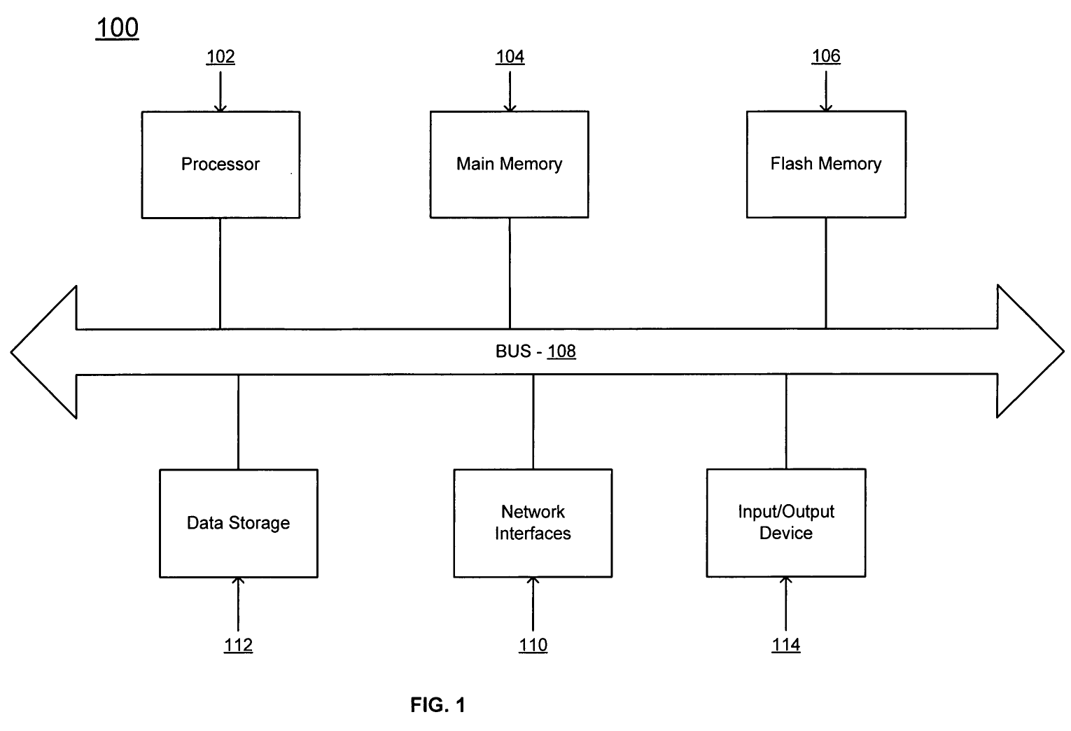

FIG. 1 is a block diagram illustrating a suitable computing environment in which certain aspects of the illustrated invention may be practiced. In one embodiment, the method described above may be implemented on a computer system 100 having components 102-114, including a processor 102, a main memory 104, a flash memory 106, an Input/Output (I/O) device 114, a data storage device 112, and a network interface 110, coupled to each other via a bus 108. The components perform their conventional functions known in the art and provide the means for implementing the system 100. Collectively, these components represent a broad category of hardware systems, including but not limited to general purpose computer systems, mobile or wireless computing systems, and specialized packet forwarding devices. It is to be appreciated that various components of computer system 100 may be rearranged, and that certain implementations of the present invention may not require nor include all of the above components. Furthermore, additional components may be included in system 100, such as additional processors (e.g., a digital signal processor), storage devices, memories (e.g. RAM, ROM, or flash memory), and network or communication interfaces.

As will be appreciated by those skilled in the art, the content for implementing an embodiment of the method of the invention, for example, computer program instructions, may be provided by any machine-readable media which can store data that is accessible by system 100, as part of or in addition to memory, including but not limited to cartridges, magnetic cassettes, flash memory cards, digital video disks, random access memories (RAMs), read-only memories (ROMs), and the like. In this regard, the system 100 is equipped to communicate with such machine-readable media in a manner well-known in the art.

It will be further appreciated by those skilled in the art that the content for implementing an embodiment of the method of the invention may be provided to the system 100 from any external device capable of storing the content and communicating the content to the system 100. For example, in one embodiment of the invention, the system 100 may be connected to a network, and the content may be stored on any device in the network.

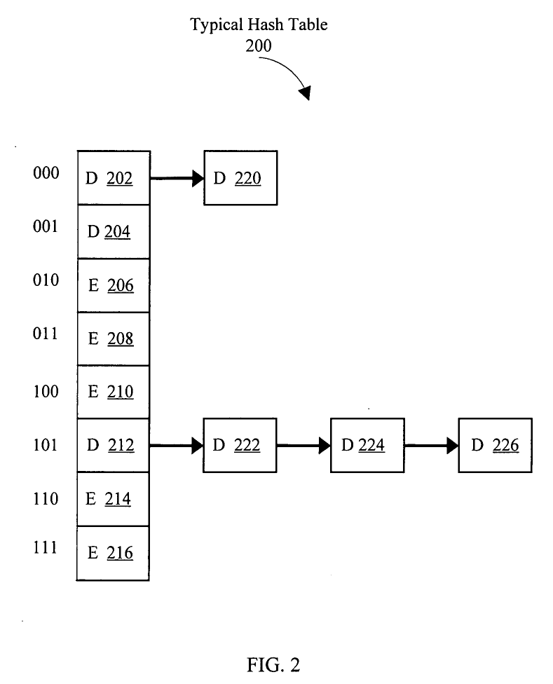

FIG. 2 illustrates a typical hash table 200. The hash table 200 contains eight cells, 202-216, at locations 000-111. There are seven data (D) entries. Two data entries are mapped to location 000. Therefore, there is a collision. To resolve this collision, a linked list is created that includes cells 202 and 220, which each contain one of the colliding data entries. Four data entries are mapped to location 101. Therefore, a linked list is created that includes four cells, 212, 222, 224, and 226 to hold each of the four data entries for location 101. Cell 204 also contains data, but since there is no collision, there is no linked list. As shown in FIG. 2, table 200 has five empty (E) cells, 206, 208, 210, 214, and 216. These cells remain empty even though there are colliding data entries at other cells that require a linked list.

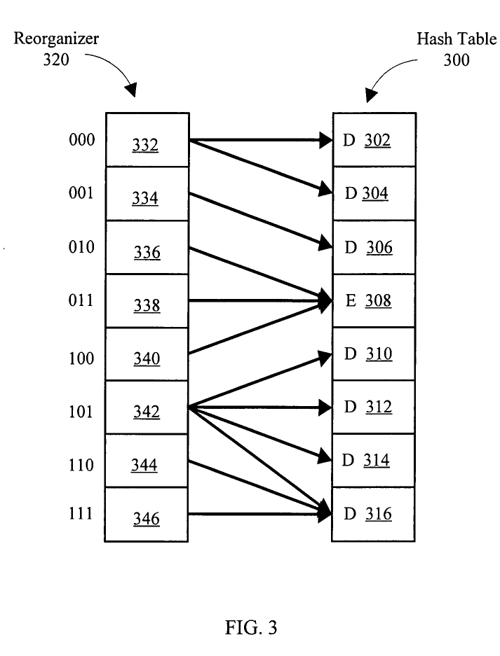

FIG. 3 illustrates a hash table according to an embodiment of the invention. A first hash function is used to hash the data into the hash table 300. For each of the cells 302-316 in the hash table 300, a reorganizer 320 determines the number of data entries that map to that cell. This information may be stored in a corresponding cell of the reorganizer, such as cells 332-346, respectively. The reorganizer 320 may also store information for remapping the data of the hash table 300. A reorganizer cell may store remap information that includes a starting cell in the hash table when the data is rehashed and a number of cells to allocate in the hash table when the data is rehashed. One or more subsequent hash functions may be determined for the cells of the hash table 300. The subsequent hash functions may be chosen to minimize the collisions of data in the hash table 300. The subsequent hash function to be used for rehashing data associated with each cell of the hash table may be stored in the corresponding cell of the reorganizer 320 along with the other remap information for that data. Then, the one or more subsequent hash functions may be used to remap the data in the hash table 300 to distribute the data.

In one embodiment, the density of the hash table is determined. The density is equal to the number of data entries divided by the total number of cells. In the hash table 300, there are seven data entries and eight total cells. Therefore, the density value for table 300 is ⅞. Since the density value is less than one, there should be enough cells in the hash table 300 to hold all the data. Therefore, each data entry should be allocated one cell.

In one embodiment, the reorganizer 320 determines a starting cell for the data in the hash table 300 and determines how many cells to allocate. This remap information may be stored in the reorganizer 320. These determinations may be based on the density value. For example, suppose that the first hash function distributed the data in a manner similar to that shown in FIG. 2, where the cells at locations 000 and 101 have colliding data. The reorganizer 320 may determine that the starting cell in the hash table 300 for the data at location 000 is cell 302. Since the density value is less than one, each data entry may be allocated one cell in the hash table 300. Therefore, since there are two data entries at location 000, two cells 302 and 304 may be allocated in the hash table 300. One cell 306 is allocated for the one data entry at location 001. Since the cells at locations 010, 011, and 100 are empty, they may all be mapped to one cell 308 in the hash table 300. Location 101 contains four data entries and therefore four cells 310, 312, 314, and 316 may be allocated in the hash table 300 for these four data entries. Since the cells at locations 110 and 111 are empty, they may be mapped to the same cell 316 in hash table 300. One or more subsequent hash functions may be used to remap the data in the hash table in the manner described above to distribute the data and minimize collisions.

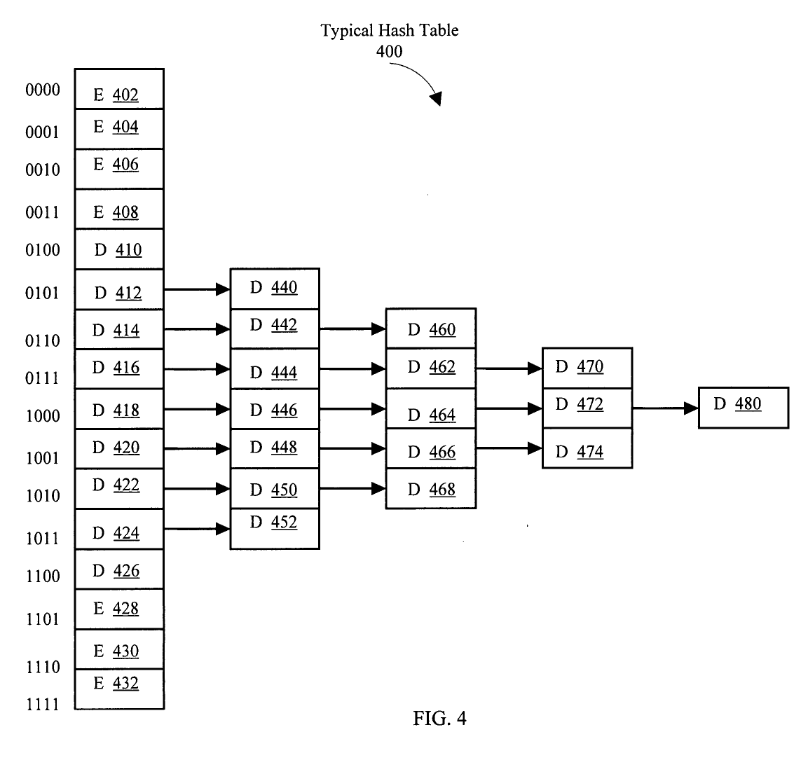

FIG. 4 illustrates a typical hash table 400. The hash table 400 contains 16 cells, 402-432, at locations 0000-1111. There are 25 data (D) entries. More than one data entry is mapped to locations 0101-1011. Therefore, there are collisions of data. To resolve these collisions, a linked list is created for each cell that has more than one mapped data entry. The additional cells in the linked list, 440-452, 460-474, and 480, store the colliding data entries. As shown in FIG. 4, table 400 has seven empty (E) cells, 402-406 and 428-432. These cells remain empty even though there are colliding data entries at other cells that require a linked list.

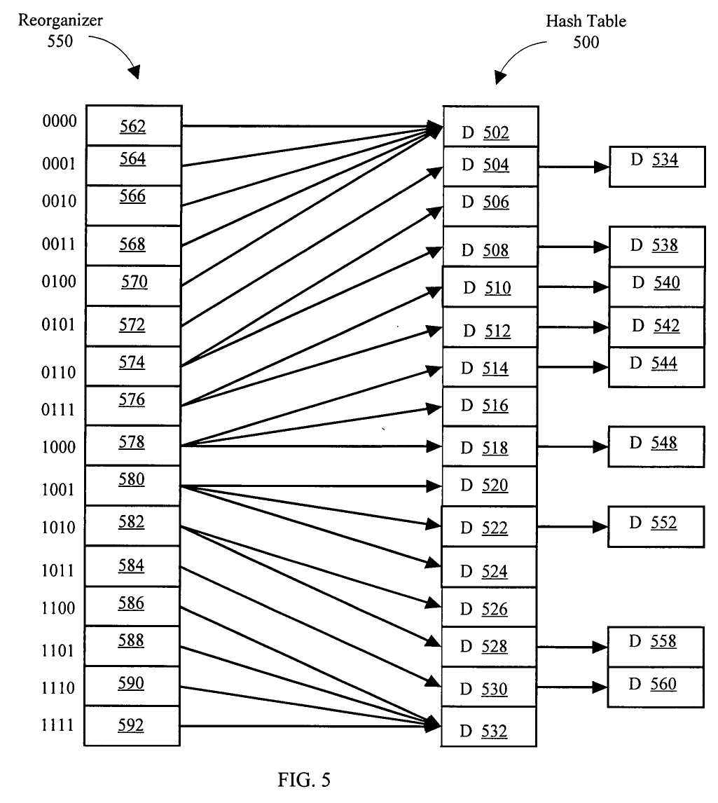

FIG. 5 illustrates a hash table according to an embodiment of the invention. A first hash function is used to hash the data into a hash table 500. For each of the cells 502-532 in the hash table 500, a reorganizer 550 determines the number of data entries that map to that cell. This information may be stored in a corresponding cell of the reorganizer, such as cells 562-592, respectively. The reorganizer 550 may also store information for remapping the data of the hash table 500. A reorganizer cell may store remap information that includes a starting cell in the hash table when the data is rehashed and a number of cells to allocate in the hash table when the data is rehashed. One or more subsequent hash functions may be determined for the cells of the hash table. The subsequent hash functions may be chosen to minimize the collisions of data in the hash table. The subsequent hash function to be used for rehashing data associated with each cell of the hash table may be stored in the corresponding cell of the reorganizer 550 along with the other remap information for that data. Then, the one or more subsequent hash functions may be used to remap the data in the hash table 500 to distribute the data.

For example, the hash table 500 contains 16 cells and 25 total data entries. Therefore, the density value for hash table 500 is 25/16, which equals 1.5625. Since the density value is more than one, there are not enough cells to hold all the data entries. Therefore, the hash table 500 will still contain colliding data after rehashing. A linked list may be used to resolve this colliding data.

Since the density value is approximately 1.5, for every one and a half data, we should move down one cell in the hash table 500. For example, suppose that the first hash function distributed the data in a manner similar to that shown in FIG. 4. The reorganizer 550 determines that the starting cell in the hash table 500 for location 000 is cell 502. Since there is only one data entry among the cells at locations 0000, 0001, 0010, 0011, and 0100, a subsequent hash function may be chosen to map all of these data entries into cell 502 of hash table 500. There are two data entries at location 0101, so a subsequent hash function may be chosen to map these two data entries to cell 504 of hash table 500. A linked list may be created to hold the colliding data entry in cell 534. Location 0110 has three data entries, so a subsequent hash function may be chosen to may these three data entries into two cells 506 and 508 in the hash table 500. This remapping process continues until all the data entries are remapped and distributed into the hash table 500 as shown in FIG. 5. The result is a hash table that contains no empty cells and nine cells that each have two data entries. Each of these nine cells (504, 508-514, 518, 522, 528, and 530) has a linked list containing an additional cell (534, 538-544, 548, 552, 558, and 560, respectively) to hold the colliding data entry.

FIG. 5 illustrates a remapping example where the resulting hash table contains no empty entries and the number of colliding data for any one cell is at most one. However, in other examples, depending on the one or more subsequent hash functions chosen for the cells in the hash table, there may still be empty cells in the hash table even when there are colliding data present for other cells. For example, a subsequent hash function may map all three data entries at location 0110 into cell 508 and leave cell 506 empty. In this case, cell 508 would have a linked list with two additional cells to hold the colliding data entries.

The same subsequent hash function may be used for one or more of the cells in the hash table. Each cell in the hash table may also have a different subsequent hash function. Examples of hash functions that may be used with embodiments of the invention include but are not limited to mod functions, polynomial functions, or secure hash functions.

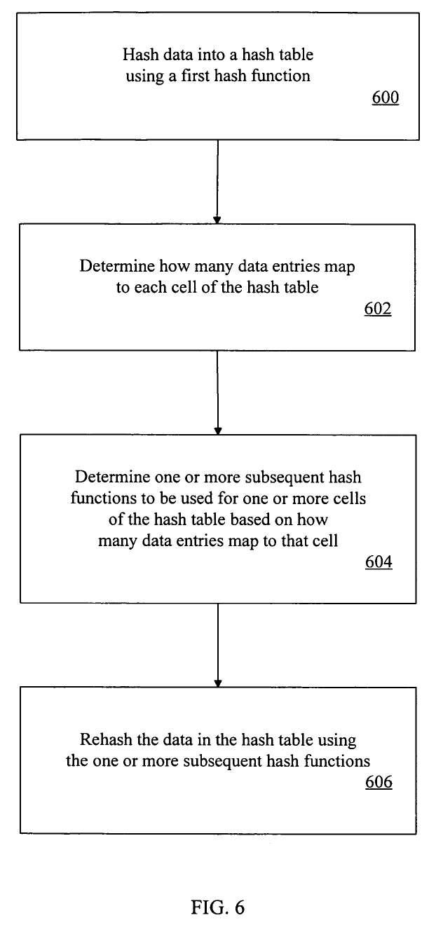

FIG. 6 illustrates a method according to one embodiment of the invention. At 600, data is hashed into a hash table using a first hash function. The hash table has a plurality of cells. At 602, the number of data entries that map to each cell of the hash table is determined. At 604, one or more subsequent hash functions to be used for the one or more cells of the hash table are determined based on the number of data entries that map to that cell. In one embodiment, the subsequent hash functions are chosen to minimize the number of collisions of data. In one embodiment, the subsequent hash function to be used for rehashing the data associated with one cell in the hash table is different than the subsequent hash function to be used for rehashing the data associated with another cell in the hash table. In one embodiment, the subsequent hash function to be used for rehashing the data associated with one cell in the hash table is the same as the subsequent hash function to be used for rehashing the data associated with another cell in the hash table.

At 606, the data is rehashed into the hash table using the one or more subsequent hash functions. In one embodiment, the first hash function is used to identify which cell in a reorganizer table will be used to store the remap information for each data entry. The reorganizer table cell storing remap information for a data entry is the equivalent cell to the hash table cell that the data entry would have been placed at using the first hash function. The remap information stored in a reorganizer table cell may include the subsequent hash function to be used to remap the data associated with that cell, the starting cell in the hash table to be used when rehashing the data associated with that cell, and the number of cells to allocate in the hash table when rehashing the data associated with that cell. The one or more subsequent hash functions may then be used in conjunction with the remap information to determine the cell in the hash table each data entry should be placed in. In one embodiment, there are still collisions in one or more cells in the hash table. Therefore, at least one of the cells in the hash table that has more than one data entry may have a linked list including one or more additional cells to hold the additional data entries. There may also be one or more empty cells in the hash table.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
hashing a plurality of data entries into a hash table using a first hash function, wherein the hash table includes a plurality of cells;
determining how many data entries map to each cell of the hash table;
determining one or more subsequent hash functions to be used for one or more cells of the hash table based on how many data entries map to that cell; and
rehashing the data entries into the hash table using the one or more subsequent hash functions.

2. The method of claim 1, wherein determining a subsequent hash function to be used for one or more cells of the hash table comprises determining how many cells to allocate in the hash table for the data entries.

3. The method of claim 2, wherein determining how many cells to allocate in the hash table comprises determining how many cells to allocate in the hash table based on a density value of the hash table.

4. The method of claim 3, wherein the density value is equal to a number of data entries in the hash table divided by a total number of cells in the hash table.

5. The method of claim 1, wherein at least one of the cells in the hash table has a linked list including one or more additional cells.

6. The method of claim 1, wherein determining one or more subsequent hash functions to be used for one or more cells of the hash table comprises identifying a subsequent hash function for each cell in the hash table.

7. The method of claim 6, further comprising storing the identified subsequent hash functions in a reorganizer table.

8. The method of claim 6, wherein rehashing the data into the hash table using the one or more subsequent hash functions comprises rehashing the data associated with each cell of the hash table using the subsequent hash function identified for that cell.

9. An article of manufacture comprising:
a machine accessible medium including content that when accessed by a machine causes the machine to perform operations including:
hashing a plurality of data entries into a hash table using a first hash function, wherein the hash table includes a plurality of cells;
determining one or more subsequent hash functions to be used for one or more cells of the hash table;
for each cell of the hash table, storing in a corresponding cell of a reorganizer table remap information for one or more of the plurality of data entries that map to that cell; and
rehashing the data in the hash table using the subsequent hash functions and the stored remap information.

10. The article of manufacture of claim 9, wherein the machine-accessible medium further includes content that causes the machine to perform operations comprising determining how many data entries map to each cell of the hash table.

11. The article of manufacture of claim 10, wherein determining one or more subsequent hash functions comprises determining one or more subsequent hash functions to minimize colliding data in the hash table.

12. The article of manufacture of claim 9, wherein the stored remap information associated with each cell of the hash table comprises the subsequent hash function to be used to remap the one or more data entries associated with that cell.

13. The article of manufacture of claim 12, wherein the subsequent hash function to be used for rehashing the data associated with one cell in the hash table is different than the subsequent hash function to be used for rehashing the data associated with another cell in the hash table.

14. The article of manufacture of claim 9, wherein the stored remap information associated with each cell of the hash table comprises a starting cell in the hash table to be used when rehashing the one or more data entries associated with that cell.

15. The article of manufacture of claim 9, wherein the stored remap information associated with each cell of the hash table comprises a number of cells to allocate in the hash table when rehashing the one or more data entries associated with that cell.

16. A system comprising:
a processor;
a flash memory coupled to the processor; and
a machine accessible medium including content that when accessed by a machine causes the machine to perform operations including:
hashing a plurality of data entries into a hash table using a first hash function, wherein the hash table includes a plurality of cells;
determining how many data entries map to each cell of the hash table;
determining one or more subsequent hash functions to be used for one or more cells of the hash table based on how many data entries map to that cell;
storing remap information for the plurality of cells in a reorganizer table, the remap information including the one or more subsequent hash functions; and
rehashing the plurality of data entries into the hash table using the stored remap information.

17. The system of claim 16, wherein the subsequent hash function to be used for rehashing the data associated with one cell in the hash table is different than the subsequent hash function to be used for rehashing the data associated with another cell in the hash table.

18. The system of claim 16, wherein storing remap information for the plurality of cells in the reorganizer table comprises storing remap information for each of the plurality of cells of the hash table in an equivalent cell of the reorganizer table.

19. The system of claim 18, wherein the remap information for each of the plurality of cells includes a starting cell in the hash table to be used when rehashing the data associated with that cell.

20. The system of claim 19, wherein the remap information for each of the plurality of cells includes a number of cells to allocate in the hash table when rehashing the data associated with that cell.
